(19) United States
(12) Patent Application Publication
(10) Pub. No.: US 2022/0308595 A1
(43) Pub. Date: Sep. 29, 2022

(54) METHOD AND SYSTEM FOR PRECISE POSITIONING OF HEIGHT BASED ON GNSS

(71) Applicant: ELECTRONICS AND TELECOMMUNICATIONS RESEARCH INSTITUTE, Daejeon (KR)

(72) Inventors: Yoola HWANG, Daejeon (KR); Jae Young AHN, Daejeon (KR); Jihun CHA, Daejeon (KR)

(21) Appl. No.: 17/524,432

(22) Filed: Nov. 11, 2021

(30) Foreign Application Priority Data
Mar. 24, 2021 (KR) 10-2021-0038123

(51) Int. Cl. G05D 1/06; G01W 1/02; G01S 19/42; B64C 39/02

(52) U.S. Cl. CPC G05D 1/0607; G01W 1/02; G01S 19/42; B64C 39/024; B64C 2201/145

(57) ABSTRACT

Disclosed are a method and system for precise height positioning based on global navigation satellite system (GNSS). A precise height positioning method may include determining an orthometric height based on a barometric pressure and a temperature of a region where an unmanned aerial vehicle is located, determining a geoid height in accordance with GNSS positioning information of the unmanned aerial vehicle, and determining a final altitude based on a difference between an ellipsoidal height in accordance with the orthometric height and the geoid height and an ellipsoidal height included in the GNSS positioning information.

### CROSS-REFERENCE TO RELATED APPLICATION

This application claims the benefit of Korean Patent Application No. 10-2021-0038123 filed on Mar. 24, 2021, in the Korean Intellectual Property Office, the entire disclosure of which is incorporated herein by reference for all purposes.

### BACKGROUND 1. Field of the Invention

One or more example embodiments relate to a method and system for precise height positioning based on global navigation satellite system (GNSS) and more particularly, to a method and system for precise height positioning of an unmanned aerial vehicle using GNSS and an altitude sensor.

2. Description of the Related Art

A navigation system based on GNSS may have a real-time kinematics (RTK) accuracy of a few centimeters in an open terrain. However, in downtown, a street with trees, or a location with severe interference, a signal may be blocked, or a quality of data may be insufficient for positioning. Thus, a reliability may decrease.

Thus, a conventional method for height positioning, that is, positioning a height of an unmanned aerial vehicle using GNSS provides unreliable height information since a position error in a vertical direction drastically increases in an area where a geometric dilution of precision (GDOP) is poor such as downtown.

Thus, there is a desire for a method for an unmanned aerial vehicle to precisely position a height in a shaded area such as downtown.

### SUMMARY

Example embodiments provide a method and system for precisely measuring a final altitude of an unmanned aerial vehicle in a region with a low availability of global navigation satellite system (GNSS) by determining the final altitude of the unmanned aerial vehicle using an ellipsoidal height calculated based on an orthometric height measured by a barometric altimeter and an ellipsoidal height included in GNSS positioning information.

In addition, example embodiments provide a method and system for correcting an orthometric height measured by the barometric altimeter in accordance with a sea level pressure and a reference temperature updated by a meteorological center server.

According to an aspect, there is provided a precise height positioning method including determining an orthometric height based on a barometric pressure and a temperature of a region where an unmanned aerial vehicle is located, determining a geoid height in accordance with global navigation satellite system (GNSS) positioning information of the unmanned aerial vehicle, and determining a final altitude based on a difference between an ellipsoidal height in accordance with the orthometric height and the geoid height and an ellipsoidal height included in the GNSS positioning information.

The precise height positioning method, wherein the determining of the orthometric height may include determining the orthometric height of an unmanned aerial vehicle in accordance with the barometric pressure around the unmanned aerial vehicle, determining a latitude and a longitude of the region based on GNSS positioning information, confirming identification information of the region in accordance with the latitude and the longitude, retrieving a sea level pressure and a reference temperature corresponding to a current time of the region in accordance with the identification information from a database storing weather information, and correcting the orthometric height based on the sea level pressure and the reference temperature.

The precise height positioning method, wherein the determining of the geoid height may include determining a latitude and a longitude of the region based on GNSS positioning information at a current time or GNSS positioning information at a previous time, and retrieving a geoid height corresponding to the latitude and the longitude from a database storing geoid heights for respective grids.

The precise height positioning method, wherein the retrieving of the geoid height may include applying a two-dimensional interpolation method to the latitude and the longitude, and retrieving a geoid height corresponding to the latitude and the longitude to which the two-dimensional interpolation method is applied.

The precise height positioning method, wherein in the database storing the geoid height for respective grids, gaps between the grids and latitudes and longitudes of the respective grids may be set, and geoid heights to which geographic weights are applied in accordance with the latitudes and the longitudes of the respective grids may be managed through matching to the respective grids.

The precise height positioning method, wherein the determining of the final altitude may include calculating the ellipsoidal height by adding the geoid height to the orthometric height, and determining the final altitude by correcting the ellipsoidal height included in the GNSS positioning information in accordance with a result of optimizing a difference between the calculated ellipsoidal height and the ellipsoidal height included in the GNSS positioning information.

According to an aspect, there is provided a system for precise height positioning including a barometric altimeter configured to determine an orthometric height based on a barometric pressure and a temperature of a region where an unmanned aerial vehicle is located, and a processor configured to determine a geoid height in accordance with GNSS positioning information received by a GNSS receiver and determine a final altitude based on a difference between an ellipsoidal height in accordance with the orthometric height and the geoid height and an ellipsoidal height included in the GNSS positioning information.

The system for precise height positioning may further include an updater configured to determine a latitude and a longitude of the region based on GNSS positioning information, confirm identification information of the region in accordance with the latitude and the longitude, and retrieve a sea level pressure and a reference temperature corresponding to a current time of the region in accordance with the identification information from a database storing weather information, wherein the barometric altimeter is further configured to correct the orthometric height based on the sea level pressure and the reference temperature.

The system for precise height positioning, wherein the processor may be further configured to determine the latitude and the longitude of the region based on GNSS positioning information at a current time or GNSS positioning information at a previous time, and retrieve a geoid height corresponding to the latitude and the longitude from a database storing geoid heights for respective grids.

The system for precise height positioning, wherein the processor may be further configured to apply a two-dimensional interpolation method to the latitude and the longitude, and retrieve a geoid height corresponding to the latitude and the longitude to which the two-dimensional interpolation method is applied.

The system for precise height positioning, wherein in the database storing the geoid height for respective grids, gaps between the grids and latitudes and longitudes of the respective grids may be set, and geoid heights to which geographic weights are applied in accordance with the latitudes and the longitudes of the respective grids may be managed through matching to the respective grids.

The system for precise height positioning, wherein the processor may be further configured to calculate the ellipsoidal height by adding the geoid height to the orthometric height, and determine the final altitude by correcting the ellipsoidal height included in the GNSS positioning information in accordance with a result of optimizing a difference between the calculated ellipsoidal height and the ellipsoidal height included in the GNSS positioning information.

Additional aspects of example embodiments will be set forth in part in the description which follows and, in part, will be apparent from the description, or may be learned by practice of the disclosure.

According to example embodiments, a final altitude of an unmanned aerial vehicle may be precisely measured in a region with a low availability of GNSS by determining the final altitude of the unmanned aerial vehicle using an ellipsoidal height calculated based on an orthometric height measured by a barometric altimeter and an ellipsoidal height included in GNSS positioning information.

In addition, an orthometric height measured by the barometric altimeter may be corrected in accordance with a sea level pressure and a reference temperature updated by the meteorological center server. The site for meteorological center server is linked to the city name searched by the UAV position of longitude and latitude determined at the previous time via the mission control (MC) board processor. The linked meteorological site in real-time provides current temperature and sea-level pressure to the UAV MC board whenever the current temperature and pressure are updated. Here the city names and positions are listed like a database on MC board.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a precise height positioning system according to an example embodiment;

FIG. 2 is a diagram illustrating a process of updating a sea level pressure and a reference temperature according to an example embodiment;

FIG. 3 is a diagram illustrating a concept of an orthometric height, a geoid height and an ellipsoidal height;

FIG. 4 is a diagram illustrating a process of calculating a geoid height according to an example embodiment; and

FIG. 5 is a flowchart illustrating a precise height positioning method according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Hereinafter, example embodiments will be described in detail with reference to the accompanying drawings.

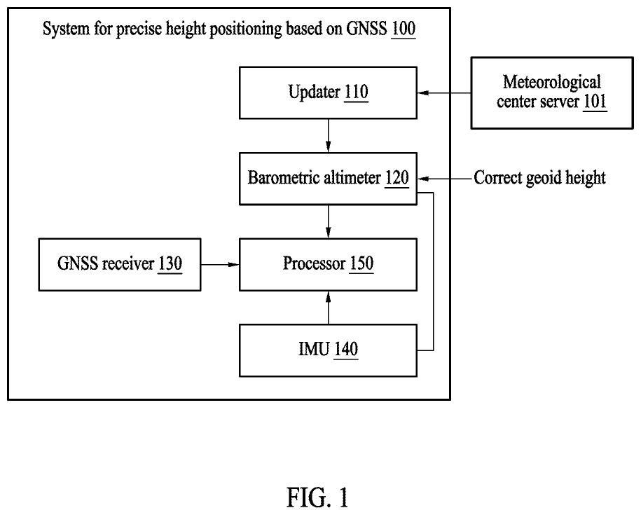

FIG. 1 is a diagram illustrating a precise height positioning system according to an example embodiment.

A precise height positioning system based on global navigation satellite system (GNSS) 100 may be installed into an unmanned aerial vehicle and may include an updater 110, a barometric altimeter 120, a GNSS receiver 130, an inertial measurement unit (IMU) 140, and a processor 150, as shown in FIG. 1.

The precise height positioning system based on GNSS 100 may determine a position and a velocity of the unmanned aerial vehicle by integrating GNSS-based navigation information and an accelerometer and gyro data of the IMU 140. In addition, the precise height positioning system based on GNSS 100 may perform precise positioning by converting an orthometric height measured by the barometric altimeter 120 into an ellipsoidal height scale and correcting an ellipsoidal height calculated based on GNSS.

The updater 110 may retrieve a sea level pressure and a reference temperature corresponding to a current time of a region where the unmanned aerial vehicle is located, from a database storing weather information such as a meteorological center server 101. In addition, the updater 110 may update a sea level pressure and a reference temperature to be inputted into the barometric altimeter 120 in accordance with the retrieved sea level pressure and the reference temperature. For example, the updater 110 may be a communicator to communicate with the meteorological center server 101 via wireless communication such as wireless fidelity (Wi-Fi) and long-term evolution (LTE).

The barometric altimeter 120 may measure a barometric pressure around the unmanned aerial vehicle. In addition, the barometric altimeter 120 may determine an orthometric height of the unmanned aerial vehicle based on the measured barometric pressure and transmit the orthometric height to the processor 150. Here, the updater 110 may determine a latitude and a longitude of an approximate region where the unmanned aerial vehicle is located based on GNSS positioning information. In addition, the updater 110 may confirm identification information of the region where the unmanned aerial vehicle is located, based on the determined latitude and the longitude. In addition, the updater 110 may retrieve a sea level pressure and a reference temperature corresponding to a current time of the region where the unmanned aerial vehicle is located, based on the identification information of the region from the database storing weather information such as the meteorological center server 101.

The GNSS receiver 130 may receive GNSS positioning information obtained by GNSS. Here, the GNSS positioning information may be a stand-alone information or positioning information obtained through real-time positioning by removing errors such as an ionospheric error and a multipath error of observation data, clock errors of a receiver and GNSS satellites, and a hardware bias. The GNSS positioning information may include the ellipsoidal height, the latitude and the longitude of the unmanned aerial vehicle.

The IMU 140 may measure a velocity, a real time acceleration, a gyro, a direction, a gravity, and an acceleration of the unmanned aerial vehicle and provide the measured data to the processor 150.

The processor 150 may calculate a Latitude-Longitude-Height (LLH) in real time by applying noise and a bias scaling value to the real time acceleration and the gyro value of the unmanned aerial vehicle received from the IMU 140. For example, IMU information received from the IMU 140 may have a larger volume than GNSS positioning information. For example, the GNSS positioning information may be 1 Hz, and the IMU information may be 20 to 50 Hz. Here, the processor 150 may process raw data of the GNSS information and the IMU information within a second by synchronizing system times of the raw data of the GNSS information and the IMU information through synchronization in system time. Here, the processor 150 may perform the synchronization using global positioning system (GPS) time.

In addition, the processor 150 may determine a geoid height based on GNSS positioning information of the unmanned aerial vehicle. Here, the processor 150 may determine a latitude and a longitude of the region where the unmanned aerial vehicle is located based on GNSS positioning information at a current time or GNSS positioning information at a previous time. In addition, the processor 150 may retrieve a geoid height corresponding to the latitude and the longitude of the region where the unmanned aerial vehicle is located from a database storing geoid heights for respective grids. Here, the processor 150 may apply a two-dimensional interpolation method to the latitude and the longitude of the region where the unmanned aerial vehicle is located and retrieve a geoid height corresponding to the latitude and the longitude to which the two-dimensional interpolation method is applied.

In addition, in the database storing the geoid heights for respective grids, gaps between the grids and latitudes and longitudes for the respective grids may be set, and geoid heights to which geographic weights are applied in accordance with the latitudes and longitudes of the respective grids may be managed through matching to the respective grids.

Next, the processor 150 may determine a final altitude by mutually complementing based on a difference between an ellipsoidal height in accordance with an orthometric height and a geoid height and an ellipsoidal height included in GNSS positioning information. Here, the processor 150 may calculate the ellipsoidal height by adding the geoid height to the orthometric height. In addition, the processor 150 may calculate an optimal value of a difference between the calculated ellipsoidal height and the ellipsoidal height included in the GNSS positioning information. Next, the processor 150 may determine the final altitude by correcting the ellipsoidal height included in the GNSS positioning information in accordance with the calculated optimal value.

Specifically, the processor 150 may obtain a desired value by adding an altitude value of the barometric altimeter 120 to states which combine the difference between the calculated ellipsoidal height and the ellipsoidal height included in the GNSS positioning information with the GNSS positioning information and the IMU information and optimizing and correcting an error value with respect to an initial condition using a filter.

Here, since an ellipsoidal height measured by the barometric altimeter 120 may include a bias error or a scale error, the processor 150 may correct the ellipsoidal height by setting a weight to the ellipsoidal height calculated by using the orthometric height measured by the barometric altimeter 120 in accordance with a sigma value of the ellipsoidal height included in the GNSS positioning information during a process of correcting an error. Here, the sigma value may be within an error range of information. As the sigma value increases, the weight of the ellipsoidal height may decrease.

The precise height positioning system based on GNSS 100 may determine the final altitude of the unmanned aerial vehicle using the ellipsoidal height calculated based on the orthometric height measured by the barometric altimeter 120 and the ellipsoidal height included in the GNSS positioning information. Thus, the precise height positioning system based on GNSS 100 may precisely measure the final altitude of the unmanned aerial vehicle even in a region with a low availability of GNSS.

In addition, the precise height positioning system based on GNSS 100 may correct the orthometric height measured by the barometric altimeter 120 in accordance with a sea level pressure and a reference temperature updated by the meteorological center server 101.

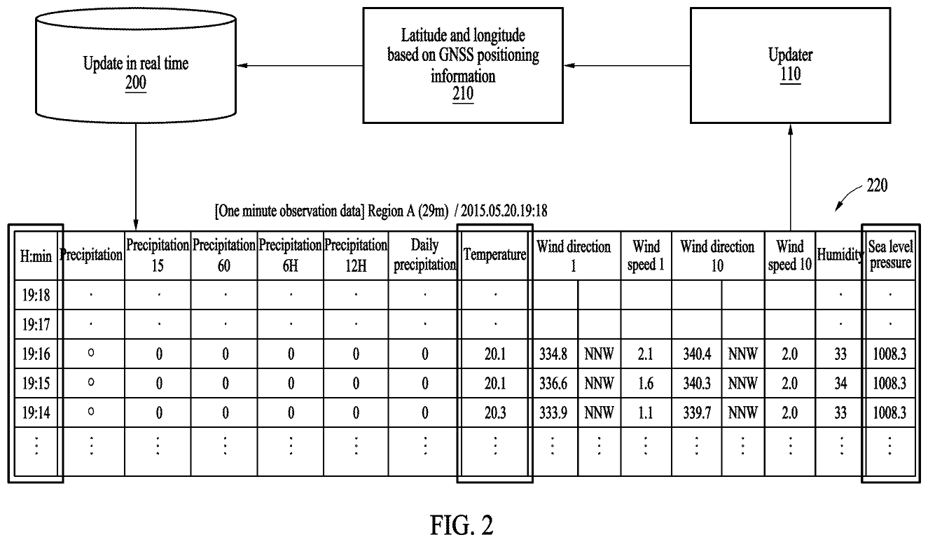

FIG. 2 is a diagram illustrating a process of updating a sea level pressure and a reference temperature according to an example embodiment.

The updater 110 may access the meteorological center server 101 via LTE or wi-fi in real time or in accordance with an update cycle of the meteorological center server 101.

Here, the processor 150 may determine a latitude and a longitude 210 of a region where the unmanned aerial vehicle is located, based on GNSS positioning information. In addition, the processor 150 may confirm identification information of the region where the unmanned aerial vehicle is located, in accordance with the determined latitude and the longitude.

Next, the processor 150 may retrieve a sea level pressure and a reference temperature 220 corresponding to a current time of the region where the unmanned aerial vehicle is located from a database 200 of the meteorological center server 101 using the identification information of the region. Here, the database 200 of the meteorological center server 101 may be updated with the sea level pressure and the reference temperature for each region in real time or in accordance with a predetermined cycle.

In addition, the processor 150 may store the identification information of the region in the updater 110. In addition, the processor 150 may transmit the latitude and the longitude 210 of the region to the updater 110 in real time or in accordance with the update cycle of the meteorological center server 101. Here, the updater 110 may retrieve the region corresponding to the identification information from the database 200 of the meteorological center server 101, retrieve the sea level pressure and the reference temperature corresponding to the latitude and the longitude 210 of the region within the retrieved information of the region, and update to the barometric altimeter 120 and the processor 150.

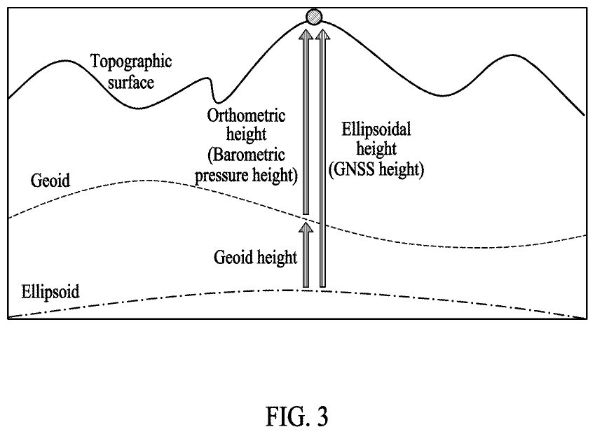

FIG. 3 is a diagram illustrating a concept of an orthometric height, a geoid height and an ellipsoidal height.

In general, an altitude value may be calculated by Equation 1.

$$H = \frac{273.15 + {T}_{0}}{Γ} \times \{ {( \frac{P}{{P}_{0}} )}^{- Γ \times \frac{R}{g}} - 1 \} ( m ) \qquad [ Equation 1 ]$$

Here, R may denote a gas constant, Γ may denote a temperature lapse rate, and g may denote a gravitational acceleration. In addition, P may denote a barometric pressure value measured by the barometric altimeter 120, and P₀ may denote a sea level pressure. In addition, T₀ may be a reference temperature, and H may be an orthometric height having a geoid as a surface.

Here, as shown in FIG. 3, an ellipsoidal height included in GNSS positioning information and an orthometric height measured by the barometric altimeter 120 may have a difference by approximately a geoid height which is a perpendicular distance between the geoid and the ellipsoid.

That is, a height included in the GNSS positioning information and a height measured by the barometric altimeter 120 may have different reference points respectively. Thus, to compare the two heights, the orthometric height measured by the barometric altimeter 120 may need a correction by the geoid height.

In addition, a value for correcting the geoid height may be determined by Equation 2.

$$z = [ \begin{matrix}{P}_{GNSS} \\ {V}_{GNSS} \\ {P ( h )}_{GNSS}\end{matrix} ] - [ \begin{matrix}{P}_{INS} \\ {V}_{INS} \\ Alt\end{matrix} ] = {H}_{LC \_ Alt} {X}_{LC \_ Alt} + {v}_{LC \_ Alt} , \qquad [ Equation 2 ]$$

$${v}_{LC / Alt} \sim N ( 0 , {R}_{LC / Alt} )$$

Here, X_{LC_Alt} may denote states representing a position, a velocity, and a height of the loose coupling coupled with a IMU (for example, Inertial navigation system, INS) loosely coupled to the barometric altimeter 120. P_{GNSS} may be a position measured by GNSS, x, y, and z. In addition, V_{GNSS} may be a velocity measured by the GNSS, vx, vy, and vz. In addition, Pms may be a position measured by INS, x, y, and z. V_{INS} may be a velocity measured by the INS, vx, vy, and vz.

P(h)_GNSS may be an ellipsoidal height value calculated by the GNSS. Alt may be an ellipsoidal height value corrected by the geoid height and the orthometric height calculated in the barometric altimeter 120.

H_{LC_Alt} may be a loosely coupled sensor matrix H (modeling to construct a relationship between observation data and the states), and V_{LC_Alt} it may be noises to the loosely coupled states.

Here, LC stands for loosely coupled.

As shown in the above equation, it may be possible to perform a new sensor-coupled positioning by an error between an integral value of a velocity, position information based on the GNSS positioning and data collected by IMU and a difference value of the barometric altimeter 120 and the GNSS. Z states may be estimated with weight information of observation data by extended Kalman filter (EKF) or other filters.

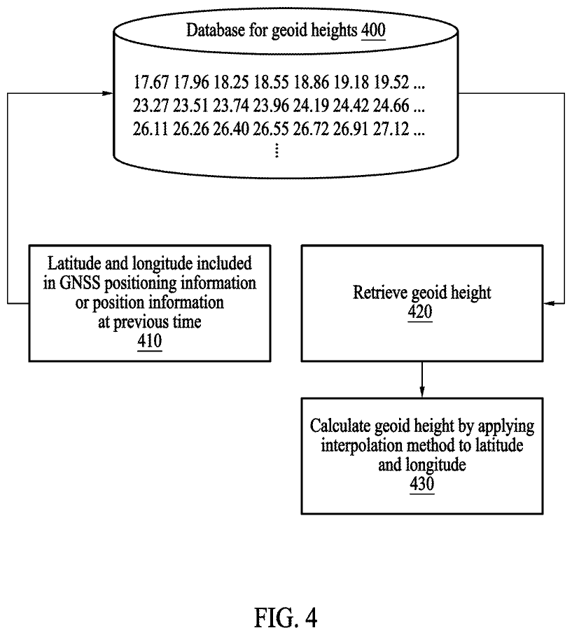

FIG. 4 is a diagram illustrating a process of calculating a geoid height according to an example embodiment.

In operation 410, the precise height positioning system based on GNSS 100 may determine a latitude and a longitude of a region where an unmanned aerial vehicle is located based on GNSS positioning information at a current time or GNSS positioning information at a previous time.

In operation 420, the precise height positioning system based on GNSS 100 may retrieve a geoid height corresponding to the latitude and the longitude of the region where the unmanned aerial vehicle is located from a database 400 storing geoid heights for respective grids. Here, in the database 400 storing the geoid heights for respective grids, gaps between the grids and latitudes and longitudes of the respective grids may be set, and geoid heights to which geographic weights are applied in accordance with the latitudes and the longitudes of the respective grids may be managed through matching to the respective grids. For example, the database 400 storing the geoid height for respective grid may be generated by datafying geoid heights calculated for respective grid points corresponding to the latitudes and the longitudes, wherein the grid points may have approximately 1 or smaller interval to min max in accordance with the latitude and the longitude of a region (for example, an administrative district) where an unmanned aerial vehicle may fly.

In operation 430, the precise height positioning system based on GNSS 100 may apply a two-dimensional interpolation method to the latitude and the longitude of the region where unmanned aerial vehicle is located and retrieve a geoid height corresponding to the latitude and the longitude to which the two-dimensional interpolation method is applied.

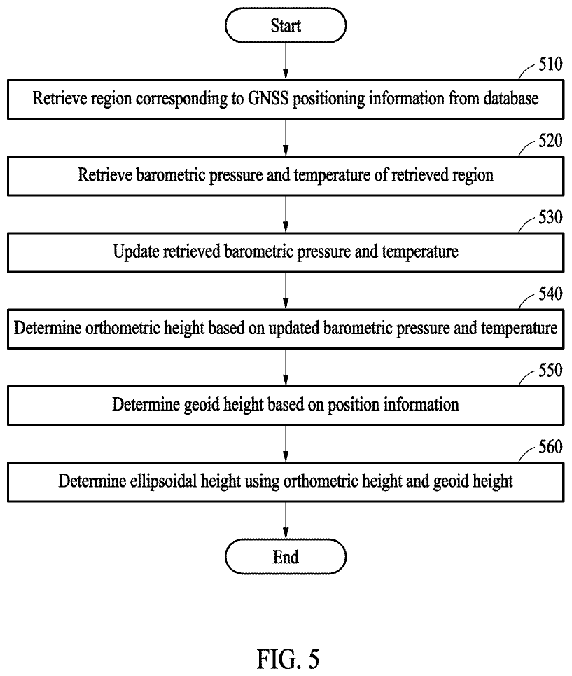

FIG. 5 is a flowchart illustrating a precise height positioning method according to an example embodiment.

In operation 510, the updater 110 may retrieve a region corresponding to GNSS positioning information from a database of the meteorological center server 101. Specifically, the updater 110 may determine a latitude and a longitude of the region where the unmanned aerial vehicle is located based on the GNSS positioning information. In addition, the updater 110 may confirm identification information of the region in accordance with the determined latitude and longitude.

In operation 520, the updater 110 may retrieve a barometric pressure and a temperature of the region retrieved in operation 510. Specifically, the updater 110 may retrieve a sea level pressure and a reference temperature corresponding to a current time of the region in accordance with the identification information of the region from the database of the meteorological center server 101.

In operation 530, the updater 110 may update the sea level pressure and the reference temperature retrieved in operation 520 to the barometric altimeter 120.

In operation 540, the barometric altimeter 120 may determine an orthometric height of the unmanned aerial vehicle based on the barometric pressure and the temperature of the region where the unmanned aerial vehicle is located. In addition, the barometric altimeter 120 may correct the orthometric height of the unmanned aerial vehicle based on the sea level pressure and the reference temperature updated in the operation 530.

In operation 550, the processor 150 may determine a geoid height in accordance with GNSS positioning information of the unmanned aerial vehicle. Here, the processor 150 may determine a latitude and a longitude of the region based on GNSS positioning information at a current time or GNSS positioning information at a previous time. Next, the processor 150 may retrieve a geoid height corresponding to the latitude and the longitude of the region from a database storing geoid heights for respective grids. Here, the processor 150 may apply a two-dimensional interpolation method to the latitude and the longitude of the region and retrieve a geoid height corresponding to the latitude and the longitude to which the two-dimensional interpolation method is applied.

In operation 560, the processor 150 may determine a final altitude based on a difference between an ellipsoidal height in accordance with the orthometric height and the geoid height and an ellipsoidal height included in the GNSS positioning information. Here, the processor 150 may calculate the ellipsoidal height by adding the geoid height to the orthometric height. Next, the processor 150 may determine the final altitude by correcting the ellipsoidal height included in the GNSS positioning information in accordance with a result of optimizing a difference between the calculated ellipsoidal height and the ellipsoidal height included in the GNSS positioning information.

According to example embodiments, by determining the final altitude of the unmanned aerial vehicle using the ellipsoidal height calculated based on the orthometric height measure by the barometric altimeter 120 and the ellipsoidal height included in the GNSS positioning information, the final altitude of the unmanned aerial vehicle may be precisely measured in a region with a low availability of GNSS.

In addition, the orthometric height measured by the barometric altimeter 120 may be corrected in accordance with the sea level pressure and the reference temperature updated by the meteorological center server 101.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The precise height positioning apparatus or the precise height positioning method may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A precise height positioning method comprising:
determining an orthometric height based on a barometric pressure and a temperature of a region where an unmanned aerial vehicle is located;
determining a geoid height in accordance with global navigation satellite system (GNSS) positioning information of the unmanned aerial vehicle; and
determining a final altitude based on a difference between an ellipsoidal height in accordance with the orthometric height and the geoid height and an ellipsoidal height included in the GNSS positioning information.

2. The method of claim 1, wherein the determining of the orthometric height comprises:
determining the orthometric height of an unmanned aerial vehicle in accordance with the barometric pressure around the unmanned aerial vehicle;
determining a latitude and a longitude of the region based on GNSS positioning information;
confirming identification information of the region in accordance with the latitude and the longitude;
retrieving a sea level pressure and a reference temperature corresponding to a current time of the region in accordance with the identification information from a database storing weather information; and
correcting the orthometric height based on the sea level pressure and the reference temperature.

3. The method of claim 1, wherein the determining of the geoid height comprises:
determining a latitude and a longitude of the region based on GNSS positioning information at a current time or GNSS positioning information at a previous time; and
retrieving a geoid height corresponding to the latitude and the longitude from a database storing geoid heights for respective grids.

4. The method of claim 3, wherein the retrieving of the geoid height comprises:
applying a two-dimensional interpolation method to the latitude and the longitude; and
retrieving a geoid height corresponding to the latitude and the longitude to which the two-dimensional interpolation method is applied.

5. The method of claim 3, wherein in the database storing the geoid height for respective grids, gaps between the grids and latitudes and longitudes of the respective grids are set, and geoid heights to which geographic weights are applied in accordance with the latitudes and the longitudes of the respective grids are managed through matching to the respective grids.

6. The method of claim 1, wherein the determining of the final altitude comprises:
calculating the ellipsoidal height by adding the geoid height to the orthometric height; and
determining the final altitude by correcting the ellipsoidal height included in the GNSS positioning information in accordance with a result of optimizing a difference between the calculated ellipsoidal height and the ellipsoidal height included in the GNSS positioning information.

7. A non-transitory computer-readable storage medium storing instructions that, when executed by a processor, cause the processor to perform the method of claim 1.

8. A system for precise height positioning comprising:
a barometric altimeter configured to determine an orthometric height based on a barometric pressure and a temperature of a region where an unmanned aerial vehicle is located; and
a processor configured to determine a geoid height in accordance with GNSS positioning information received by a GNSS receiver and determine a final altitude based on a difference between an ellipsoidal height in accordance with the orthometric height and the geoid height and an ellipsoidal height included in the GNSS positioning information.

9. The system of claim 8, further comprising:
an updater configured to determine a latitude and a longitude of the region based on GNSS positioning information, confirm identification information of the region in accordance with the latitude and the longitude, and retrieve a sea level pressure and a reference temperature corresponding to a current time of the region in accordance with the identification information from a database storing weather information,
wherein the barometric altimeter is further configured to correct the orthometric height based on the sea level pressure and the reference temperature.

10. The system of claim 8, wherein the processor is further configured to:
determine the latitude and the longitude of the region based on GNSS positioning information at a current time or GNSS positioning information at a previous time, and
retrieve a geoid height corresponding to the latitude and the longitude from a database storing geoid heights for respective grids.

11. The system of claim 10, wherein the processor is further configured to:
apply a two-dimensional interpolation method to the latitude and the longitude, and
retrieve a geoid height corresponding to the latitude and the longitude to which the two-dimensional interpolation method is applied.

12. The system of claim 10, wherein in the database storing the geoid height for respective grids, gaps between the grids and latitudes and longitudes of the respective grids are set, and geoid heights to which geographic weights are applied in accordance with the latitudes and the longitudes of the respective grids are managed through matching to the respective grids.

13. The system of claim 8, wherein the processor is further configured to:
calculate the ellipsoidal height by adding the geoid height to the orthometric height, and
determine the final altitude by correcting the ellipsoidal height included in the GNSS positioning information in accordance with a result of optimizing a difference between the calculated ellipsoidal height and the ellipsoidal height included in the GNSS positioning information.
